(19) United States
(12) Patent Application Publication
(10) Pub. No.: US 2006/0088799 A1
(43) Pub. Date: Apr. 27, 2006

(54) Dental impression trays

(76) Inventors: William Dorfman, Beverly Hills, CA (US); Kasey Soll, Los Angeles, CA (US)

Correspondence Address: Michael Bergman;Bergman Kuta LLP, P.O. Box 400167, Cambridge, MA, 02140, US

(21) Appl. No.: 11/195,430

(22) Filed: Aug. 2, 2005

Related U.S. Application Data
(60) Provisional application No. 60/598,339, filed on Aug. 2, 2004.

(51) Int. Cl. A61C 9/00

(52) U.S. Cl. 433/38

(57) ABSTRACT

Impression trays for taking dental impression of a subject are discussed herein with particular discussion extended to impression trays know as triple trays. Triple trays are so coined for their ability to simultaneously capture the upper and lower impressions and the bite registration of a subject during a same dental procedure. The trays described elsewhere herein incorporate features that strengthen or increase the rigidity of the frame so that an impression taken of the dentition of the subject using one of the trays described elsewhere herein is not distorted and is therefore an accurate reflection of the true dentition.

### CROSS REFERENCE

This application claims the benefit of U.S. provisional patent application No. 60/598,339, filed Aug. 2, 2004, entitled “Dental Impression Trays”, the content of which is hereby expressly incorporated by reference in its entirety.

### FIELD OF THE INVENTION

The present invention relates to dental impression trays for taking dental impressions of a subject in general. Specifically, the present invention relates to dental impression trays known as triple bite trays.

### BACKGROUND OF THE INVENTION

Triple bite trays or triple trays are well known in the dental art for taking impressions of patients' dentitions. Triple trays are so coined for their ability to simultaneously capture the upper and lower impressions and the bite registration of a subject during a same dental procedure.

While triple trays are popular among practitioners, some conventional triple trays have problems with distortion. Distortion, as can be expected, is undesirable because it results in an incorrect mold of the subject's dentition, which then leads to an incorrect model of the dentition made by pouring, for example, plaster into the incorrect mold.

Accordingly, there is a need for triple trays with greater resistance to distortion.

### SUMMARY OF THE INVENTION

The present invention may be implemented by providing a triple tray for taking an impression of a dentition including an inner wall, an outer wall having a handle attached thereto, and a screen connected to both the inner wall and the outer wall and defining at least one channel; a plurality of ribs disposed along at least one surface of the outer wall and at least one surface of the inner wall; and wherein the handle includes a dimple defined by a tapered ramp having a tapered surface having a radially outwardly incline from a flat portion of the handle towards a periphery of the handle.

In one aspect, the plurality of ribs are disposed along at least one of an inner wall surface of the outer wall and the inner wall surface of the inner wall for facilitating gripping by an impression material.

The present invention may also be practiced by providing a triple tray for taking an impression of a dentition including an inner wall, an outer wall having a handle attached thereto, and a screen connected to both the inner wall and the outer wall; a plurality of ribs disposed along at least one of an inner wall surface of the outer wall and the inner wall surface of the inner wall for facilitating gripping by an impression material; wherein a plurality of openings separate the inner wall surface of the inner wall from an outer wall surface of the inner wall, a plurality of lateral walls connected to both the inner wall surface and the outer wall surface of the inner wall, separating one opening from another opening, and wherein the handle includes a dimple defined by a ramp comprising an inclined surface extending adjacent a periphery of the handle.

The present invention further provides a triple tray for taking an impression of a dentition including a metal frame having a first elongated portion, a curved portion, a second elongated portion, and a post attached to a plastic handle having a first retaining wall, a receiving bore, and a dimple defined by a ramp including an incline extending along a periphery of the handle, wherein the post is received in the receiving bore and wherein a screen is attached to the first elongated portion, the curved portion, and the second portion of the metal frame to define an upper channel and a lower channel.

In one embodiment, the first retaining wall may include a plurality of ribs disposed along an inner wall surface of the wall for facilitating gripping by an impression material.

In another embodiment, at least a portion of the first elongated portion may include a polymeric sleeve.

In one aspect, at least a portion of the first elongated portion may be over-molded with a polymeric sleeve. In another aspect, at least a portion of the first elongated portion may be enclosed by the polymeric sleeve.

In one embodiment, at least a portion of the first elongated portion may be secured to a second retaining wall. In one aspect, the second retaining wall may include a plurality of ribs disposed along at least a portion of an inner wall surface of the retaining wall.

Other aspects and advantages of the present invention may be understood and practiced by reviewing the following description and the figures appended hereto.

### BRIEF DESCRIPTION OF THE DRAWINGS

These and other features and advantages of the present invention will become appreciated as the same become better understood with reference to the specification, claims and appended drawings wherein:

FIG. 1 is a semi-schematic perspective view of a full arch tray provided in accordance with aspects of the present invention;

FIG. 1a is a semi-schematic perspective view of the full arch tray of FIG. 1 shown with alternative ribbing configuration;

FIG. 2 is a semi-schematic end view of the full arch tray of FIG. 1 without the screen for clarity;

FIG. 3 is a semi-schematic side view of the full arch tray of FIG. 1;

FIG. 4 is a semi-schematic perspective view of a three-quarter tray provided in accordance with aspects of the present invention;

FIG. 5 is a semi-schematic plan view of the tray of FIG. 4;

FIG. 6 is a semi-schematic perspective view of an anterior tray provided in accordance with aspects of the present invention;

FIG. 6A is a semi-schematic top view of the anterior tray of FIG. 6 without the screen at the rear channel;

FIG. 7 is a semi-schematic perspective view of a posterior tray provided in accordance with aspects of the present invention;

FIG. 7a is a perspective view of the non-metal portion of the tray of FIG. 7;

FIG. 7b is a perspective view of a sleeve portion of the tray of FIG. 7;

FIG. 7c is a perspective view of the metal portion of the tray of FIG. 7c;

FIG. 8 is a semi-schematic perspective view of the tray of FIG. 7 from a different perspective;

FIG. 9 is a semi-schematic plan view of the tray of FIG. 7;

FIG. 10 is a perspective view of the handle without a bore; and

FIG. 11 shows a perspective view of an embodiment of a posterior tray of the present invention; and

FIG. 12 shows a top view of the tray of FIG. 11 of the present invention.

### DETAILED DESCRIPTION

The detailed description set forth below in connection with the appended drawings is intended as a description of the presently exemplified embodiments of a triple tray provided in accordance with practice of the present invention and is not intended to represent the only forms in which the present invention may be constructed or utilized. The description sets forth the features and the steps for constructing and using various triple trays of the present invention in connection with the illustrated embodiments. It is to be understood, however, that the same or equivalent functions and structures may be accomplished by different embodiments that are also intended to be encompassed within the spirit and scope of the invention. Also, as denoted elsewhere herein, like element numbers are intended to indicate like or similar elements or features.

Impressions of patients' teeth may be produced for a variety of purposes such as the manufacture of appliances for bite registrations, crown and bridge constructions, and the like. The present invention includes various types of impression trays adapted for use by a dentist for specific applications. These tray types may include a posterior, an anterior, a full arch, a three-quarter arch and a quadrant tray. The tray may be used simply as a carrier for an impression-forming material and to facilitate the placing and removal of the impression material in and from a patient's mouth.

In use, the tray is filled with a pliable, uncured composite such as a silicone impression material or a polyether impression material and is seated in a patient's mouth until the material sets or cures. This generally takes a few minutes' time.

The impression tray of the present invention provides sufficient rigidity to produce a good impression by minimizing distortion of the impression when the material laden tray is removed from a patient's mouth. An accurate negative impression of the tooth or teeth selected for a dental procedure may then be used to form an accurate duplicate of the patient's dentition, following which a dental appliance may be produced on a stone model or similar.

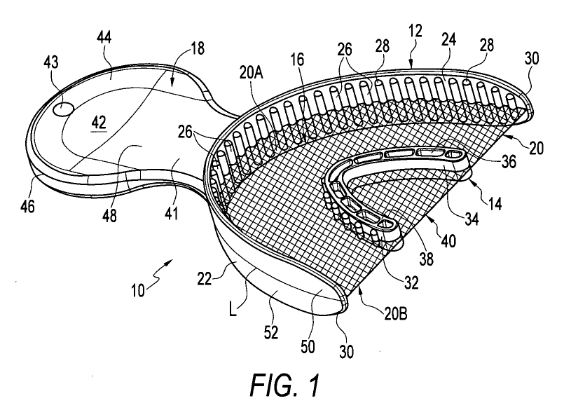

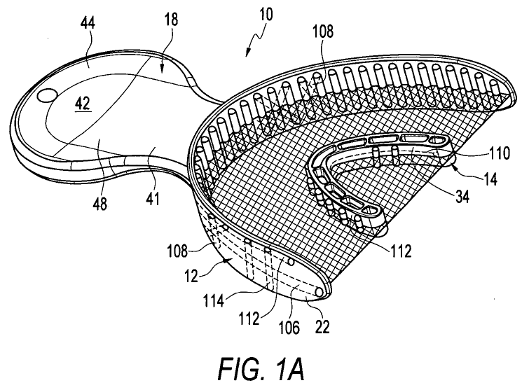

In one embodiment, as exemplified in FIG. 1, where a semi-schematic perspective view of a full arch dental impression tray is provided in accordance with aspects of the present invention. The tray 10, as shown, is s full arch tray, useful for taking a full dentition of a patient's mouth, and is, for example, symmetrical about the parting line L. The tray 10 includes a buccal wall or outer wall 12, a lingual wall or inner wall 14, a screen 16 interconnecting the two walls, and a handle 18 attached to the outer wall 12. The inner and outer walls define a channel 20 for receiving a curable impression material adapted for biting down by a patient to capture the patient's dentition. As is readily apparent, impression material may be applied to the channel 20 on both the top channel 20A and the bottom channel 20B. Any suitable impression material, including those already in the market or disclosed in prior art, for example, alginate, polyvinyl siloxane, polyether, and super-hydrophilic VPS, just to name a few, may be used with the tray 10.

The screen 16 acts as a retaining base for the impression material and may be made of any non-woven material or weaved material that is sufficiently thin to minimize the likelihood of obstructing a patient teeth during full occlusion and to not impede the making of an accurate bite on the impression material, i.e., to not prevent the upper and lower teeth from meeting. In one exemplary embodiment, the screen may be made of any woven or any non-woven material, for example, spun-bound polyester, having, for example, an average thickness of about 2.5 mil (0.06 mm) to about 5.5 mil (0.15 mm), and more for example, from about 3.5 mil (0.09 mm) to about 4.5 mil (0.11 mm). An example of a woven material may be a cotton gauze, available from Poon Cheung Kee Cotton Factory in China, a nylon mesh material or other equivalent materials. Examples of non-woven material may include those disclosed in U.S. Pat. Nos. 3,853,659; 4,340,563; 4,405,297; 4,692,106; and 5,431,986, and made commercially available from Cerex Advanced Fabrics of Cantonment, Fla. The contents of these patents are expressly incorporated herein by reference as if disclosed in full.

The outer wall 12 includes an outer wall surface 22 and an inner wall surface 24. A plurality of ribs 26 adorns the inner wall surface 24 of the outer wall 12. The plurality of ribs 26 provides surfaces for the curable impression material to adhere or attach to so that the same does not shift or separate from the tray during the impression procedure and helps to minimize distortion. In one exemplary embodiment, the ribs 26 may be substantially evenly-spaced along the inner surface 24 of the outer wall 12 and each rib may include rounded ends 28. In another embodiment, the ribs 26 may be irregularly or randomly spaced along the inner surface 24 of the outer wall 12.

In one exemplary embodiment, the plurality of ribs 26 may be generally of substantially the same height with the exception of the ribs near the edge or ends 30 of the outer wall 12, which may be made successively shorter to correspond with the, for example, tapered portions of the two ends of the outer wall 12 if present. The ends 30 of the outer wall 12 may be tapered to minimize or prevent injuries to the gingival areas of the mouth when the tray is used to take an impression of the subject's dentition.

The inner wall 14 includes an inner wall surface 32 and an outer wall surface 34. In one embodiment, a plurality of ribs 26 may also adorn the wall of the inner wall surface 32, also for facilitating gripping or adhesion by the curable impression material. In one aspect, the ribs 26 may also have rounded ends and may be substantially evenly-spaced along the inner wall surface 32 of the inner wall 14. A plurality of elliptical openings 36 separate the inner wall surface 32 from the outer wall surface 34. The lateral walls 38 between the openings 36 may function as ribs to increase rigidity of the inner wall 14, and help to minimize distortion. The openings 36 may vary in size, shape, and number, provided that a sufficient number and/or wall thickness are incorporated for rigidity. A rear channel 40, defined by the arcuate inner wall 14 and the screen 16, is not intended to hold, although may hold, curable impression material but rather to add to the structural rigidity of the tray 10 along the radial direction.

In other embodiments, such as that shown in FIG. 1a, the ribs 26 may be present in a substantially longitudinal direction 106, a substantially transverse direction 108, and combinations thereof. In the FIG. 1a embodiment, only a few representative ribs in various rib configurations are shown for clarity although it is readily recognized that an array of spaced apart ribs in various configurations may be incorporated. In other embodiments, at least one of the ribs 106, 110 may be located substantially centrally along the outside surface 22 of the outside wall 12 and the outside surface 34 of the inner wall 14, substantially proximate the parting line L. In still further embodiments, at least one of the ribs 112 may also be present along the outer edge of at least one of the inner surface 32 of the inner wall 14, the outer surface 34 of the inner wall 14, the inner surface 24 of the outer wall 12, and the outside surface 22 of the outer wall 12. As noted above, the ribs, whether present in vertical or horizontal configuration, may contribute to added stiffness of the tray 10 so that the walls may be constructed sufficiently thin without compromising the desired stiffness of the tray.

In one embodiment, at least one rib may adorn the upper and lower edges of the outer wall surface 22 of the outer wall 12, and the upper and lower edges of the outer wall surface 34 of the inner wall 14, in lieu of or addition to the plurality of ribs 26 present on the inner surface 24 of the outer wall 12 and the inner surface 32 of the inner wall 14.

In still another embodiment, at least one rib 114 adorns the outer wall surface 22 of the outer wall 12, and the outer wall surface 34 of the inner wall 14, along the longitudinal direction of the walls, in lieu of or in addition to the plurality of ribs 26 present on the inner surface 24 of the outer wall 12 and the inner surface 32 of the inner wall 14.

In still a further embodiment, at least one rib may adorn the outer wall surface 22 of the outer wall 12, and the outer wall surface 34 of the inner wall 14 substantially centrally along the parting line L of the walls. Even though the ribs have been described in detailed with respect to the full arch above, they are equally applicable to the other arches described below.

The oversized handle 18 may be, for example, attached or integrally molded to the outer wall surface 22 of the outer wall 12. The handle 18 includes a base 41, which extends from the outer wall surface 22 of the outer wall, and a dimple 42 which may be formed by incorporating a ramp 44 along the periphery 46 of the handle 18, and may, for example, resemble an amphitheatre. The dimple generally makes the tray easier to grip. In another example, the ramp 44 includes an arcuate section that has a tapered width extending along the periphery 46 of the handle in a generally U-shaped configuration. The tapered section originates at about the flat section 48 of the handle 18 and inclines as it extends radially outwardly. The ramp 44 facilitates gripping of the tray 10 by a user and the inclined section of the ramp provides a physical barrier for gripping by the user. As is readily apparent, an identical ramp 44 may be provided on the second side of the handle 18. In another exemplary embodiment, the ramp may have an incline of about 3 to about 30 degrees from horizontal. In an exemplary embodiment, the ramp 44 has a non-linear incline or a curved incline. An optional bore 43 for hanging the tray 10 or through which a tag or label (not shown) having personal identification and/or other personal information of the patient may be inserted may be included.

The base section 41 of the handle 18 is, for example, sufficiently large to further add to the structural rigidity of the outer wall 12. In an exemplary embodiment, the base section 41, at the point of attachment with outer wall 12, includes a width equivalent to about 10% to about 30% of the arc surface of the outer wall 14. The handle may also be provided with a writable surface on a portion thereof for recording the personal information of a patient. The writable portion may be raised, indented or flush with the rest of the handle. The portion is generally of the same material as the rest of the handle. It may also be separately treated or coated for better writability, i.e., for recording information.

In one exemplary embodiment, to construct a tray 10 with minimal flex or distortion when the patient bites down on the curable impression material, the tray 10 may be made from any polymer including a polystyrene (such as STYRON™ 685D, or STYRON™ A-TECH™, available form Dow Chemical Company); a polyolefin such as polyethylene, polypropylene, and polybutylene; a polyester such as polyethylene terephthalate, or polybutylene terephthalate; a polyamide, such as Nylon 66w; an acrylic polymer; polyvinylchloride; polyetherimide like ULTEM®; a polycarbonate or polycarbonate (PC) blends such as a polymeric alloy like Xenoy® resin, which is a composite of polycarbonate and polybutyleneterephthalate or Lexan® plastic, which is a copolymer of polycarbonate and isophthalate terephthalate resorcinol resin (all available from GE Plastics); other rigid materials including polyformaldehyde (available as DELRIN®), polyaryletheretherketone (PEEK), polyphenylene sulphide, acrylonitrile butadiene styrene (ABS), polyacetals; liquid crystal polymers, such as an aromatic polyester or an aromatic polyester amide containing, as a constituent, at least one compound selected from the group consisting of an aromatic hydroxycarboxylic acid (such as hydroxybenzoate (rigid monomer), hydroxynaphthoate (flexible monomer), an aromatic hydroxyamine and an aromatic diamine, (exemplified in U.S. Pat. Nos. 6,242,063, 6,274,242, 6,643,552 and 6,797,198, the contents of which are incorporated herein by reference), polyesterimide anhydrides with terminal anhydride group or lateral anhydrides (exemplified in U.S. Pat. No. 6,730,377, the content of which is incorporated herein by reference) or combinations thereof.

In addition, any polymeric composite such as engineering prepregs or composites, which are polymers filled with pigments, carbon particles, silica, glass fibers, conductive particles such as metal particles or conductive polymers; or mixtures thereof may also be used. For example, a blend of polycarbonate and ABS (Acrylonitrile Butadiene Styrene), a mixture of polyamides, such as nylon 66w and fiberglass material, may be used.

In an exemplary embodiment, the wall thickness of the outer wall 12 and the inner wall 14 may be, for example, about 1/32″ (about 0.8 mm) to about ¼″ (about 6 mm) thick, more for example, about 1/16″ (about 1.5 mm) to about ⅕″ (about 5 mm). In general, the combination of ribs, their location and arrangement, the thickness of the walls as well as the type of material used in their construction, all may contribute to the desired stiffness. Thus, if the ribs are strategically located, the material choice may not be as critical, and polymers and composites including polymers such as polyethylene terephthalate, polybutylene terephthalate, polystyrene, or polypropylene, maybe used in the construction of the trays. In fact, if the ribs are strategically located, the thickness of the walls may actually be decreased without compromising the rigidity. In addition, a combination of different materials and composites may be used in making different components of the tray, such as making the outer wall 12 from one material and the inner wall 14 from a composite. Also, the thickness of the walls may not be uniformly across the wall. In one embodiment, the wall may also be tapered towards the edges.

In one exemplary embodiment, the tray 10 may be made by co-molding the inner wall 14, the outer wall 12, and the handle 18 with the screen 16. In another exemplary embodiment, the tray 10 may be made from a separate upper tray part 50 and lower tray part 52 and snap-fit together along the centerline L via a plurality of detent engagements. In a further embodiment, the tray 10 may be made from a separate upper tray part 50 and lower tray part 52 and attached together using heat seal or an adhesive.

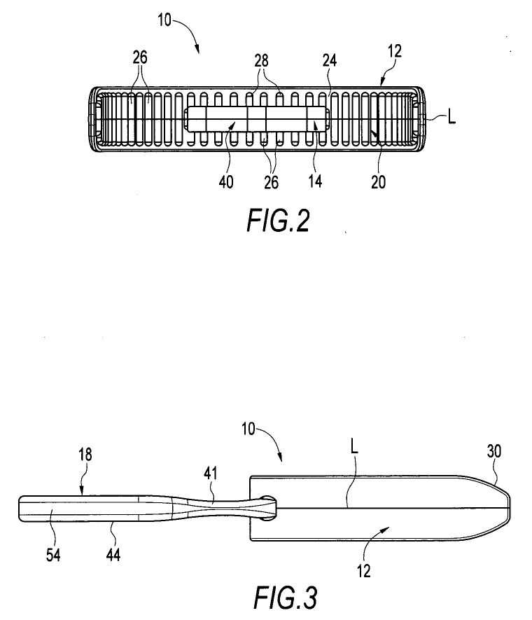

Referring now to FIG. 2, an end view of the tray 10 looking from the perspective of the rear channel 40 of the outer wall 14 towards the inner wall surface 24 of the outer wall 12 is shown, without the screen 16 for clarity. As can be seen, the wall dimension or height measured from the parting line L for the inner wall 14 may be different than the wall dimension measured from the parting line L for the outer wall 12. The outer wall 12 is higher or greater than the inner wall 14 as shown, and as the patient bites down on the curable impression material, the curable material may not flow extra-orally or outside of the mouth. However, some amount of over flow of curable impression material flowing from the main channel 20 into the rear channel 40 when an impression is taken may occur.

Although not shown, the tray 10 may be made proportionately smaller for taking the full dentition of a smaller person or made larger for a larger person.

Referring now to FIG. 3, a side view of the tray 10 is shown. In one exemplary embodiment, the handle 18 includes a width at its rear section 54 that is larger than the width at its neck section 41. As is readily apparent to a person of ordinary skill in the art, the added width is due to the additional width of the tapered wall section or ramp 44. In comparison to the width of the outer wall 12, the width at the rear section 54 has a width that is, for example, about 20% to about 50% of the width of the outer wall, more for example, about 25% to about 35%. The width at the neck section 41 is, for example, about 10% to about 40% of the width of the outer wall, more for example, about 15% to 25%.

Without wishing to be bound to a theory, it is surmised that the wide handle, for example, the width of the neck section of the handle, may also contribute to the rigidity of the trays to minimize distortion of any impressions made.

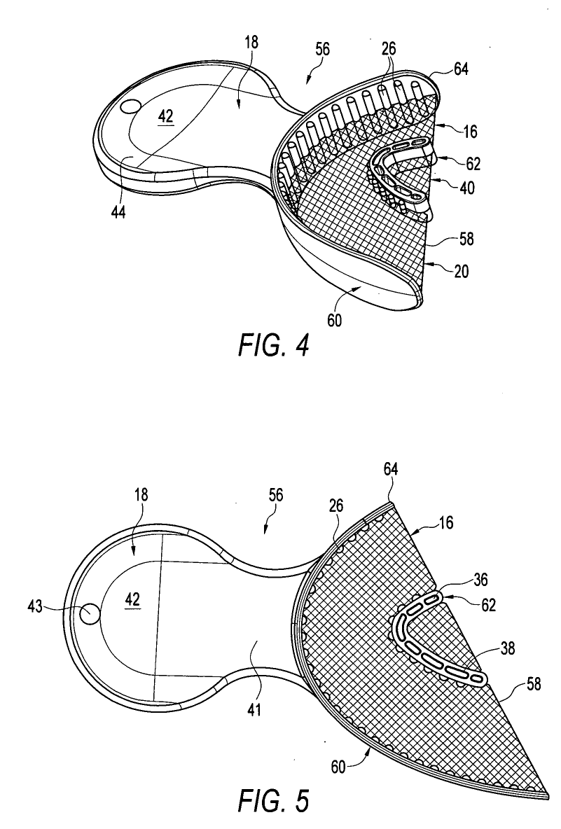

Referring now to FIG. 4, a three quarter tray 56 (herein ¾-tray) for taking ¾ of a dentition is shown. The ¾-tray 56 is similar to the full arch tray 10 described above with reference to FIGS. 1-3 with the exception that a portion of the outer wall 60 and the inner wall 62 on one side of the plane defined by the centerline of the handle 18, along the lengthwise direction, have been reduced or shortened. The ¾ tray 56 may be configured to take an impression of an entire one side of the upper and lower teeth and through the first bicuspid of the other side of the upper and lower teeth, thus so named ¾ tray. Thus, the amount or portion of the outer and inner walls to be shortened to make the ¾ tray is dependent on the amount of tray necessary to take an impression of an entire one side of the dentition and through the first bicuspid of the other side of the teeth. A bigger person may also need a bigger ¾ tray than a smaller person. The outer wall 60 and inner wall 62 of the ¾ tray 56 may have points that substantially terminate or align along a linear line 58 defined by the edge of the screen 16.

Referring now to FIG. 5, a top plan view of the ¾ tray 56 of FIG. 4 is shown. In an exemplary embodiment, the base section 41, at the point of attachment with outer wall 60, includes a width equivalent to, for example, about 25% to about 45% of the arc surface of the outer wall 60. The handle 18 is otherwise the same as the handle of FIGS. 1-3 and includes a amphitheatre or dimple 42, defined by the ramp 44. In one exemplary embodiment, the end or tip 64 of the outer wall 60 at the shortened side of the wall may also be tapered, as shown in FIG. 4, in the same manner as the taper shown in FIG. 1.

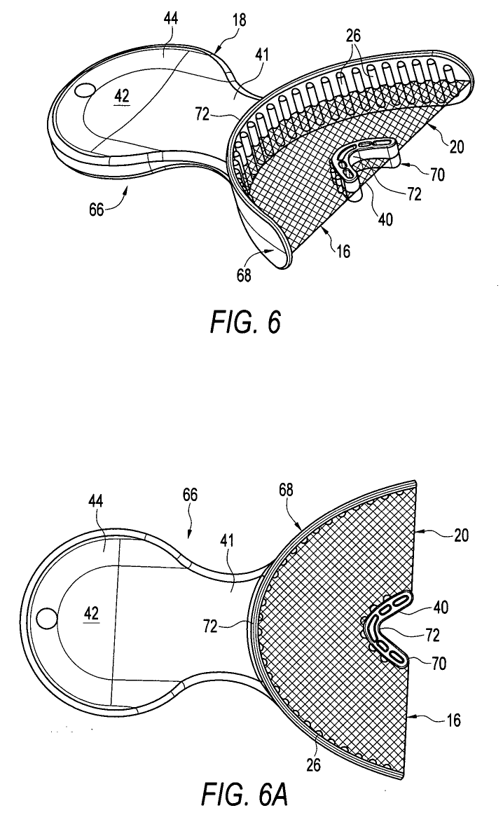

Referring now to FIG. 6, an anterior tray 66 for taking an impression of the anterior (incisor and cuspid) portion of a patient's dentition is shown. The anterior tray 66 is similar to the full arch tray 10 described above with reference to FIG. 1, except that the wall portions of the outer wall 68 and the inner wall 70 do not extend as far from the origin 72 or tip of the inner and outer walls. The arc length of the inner and outer walls 68, 70, may extend from the origin 72 a sufficient amount to enable coverage of the anterior portion of the patient's dentition. In one exemplary embodiment, the handle 18 is of the same size and configuration as the handle of FIGS. 1-3. here again, a bigger size may be needed for a bigger person and a smaller size for a smaller person.

FIG. 6A is a semi-schematic top plan view of the anterior tray 66 of FIG. 6. In the figure shown, the screen 16 is absent from the rear channel 40, which may be an alternative method for practicing the triple trays including comprising a rear channel of the present invention.

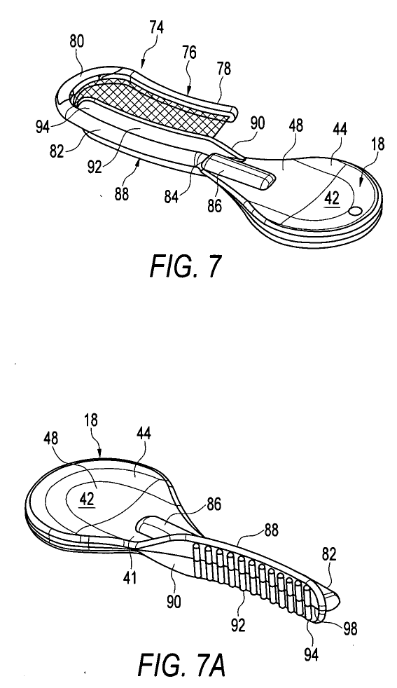

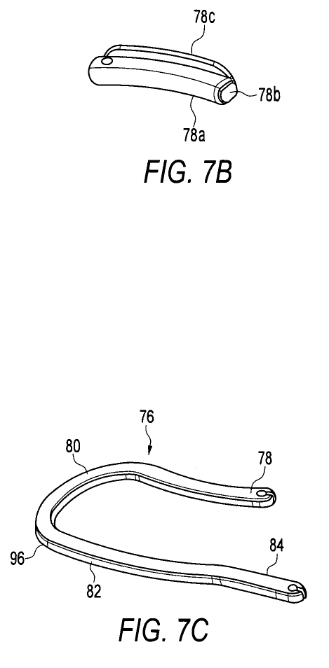

FIG. 7 is an isometric view of a posterior tray 74 for taking an impression of the posterior (bicuspid and molar) portion of a patient's dentition. In the orientation shown, the tray 74 is designed to take an impression of the posterior portion of the right side of the patient's dentition. By turning the same tray 74 upside-down, it may be used to take an impression of the left side of the patient's dentition.

The tray 74 may be a hybrid in that it may include portions made from plastic and portions made from metal. The plastic portion or portions may include any of the above mentioned polymer or polymeric composites, for example, polystyrene or a composite such as nylon 66w with 40% by weight fiberglass. The metal portion or portions may be of any light weight metal having structural integrity, and may include, but not limited to aluminum; stainless steel; magnesium or its alloys; brass; copper; an alloy such as Ni/Ti alloy; any amorphous metals including those available from Liquid Metal, Inc. or similar ones, such as those described in U.S. Pat. No. 6,682,611, and U.S. Patent Application No. 2004/0121283, the entire contents of which are incorporated herein by reference, or combinations thereof.

The metal portion may include an elongated U-shaped frame 76, which has a first elongated portion 78, a curved portion 80, and a second elongated portion 82 including a post 84, as shown in FIGS. 7 and 7c. The curve portion 80 of the frame 76, for example, may include a flat portion or surface having a width sufficiently thin to fit between the gums behind the second or third molars when bit down by a subject.

The polymeric portion of the tray 74, as shown in FIGS. 7 and 7a, may include a handle portion 18, a receiving bore 86, and a retaining wall 88, which, in the presently exemplified embodiment, may include a single integrally cast or molded piece or separately cast or molded parts and then assembled into one piece. In one exemplary embodiment, the retaining wall 88 may include a first section 90 adjacent the handle 18 and a second section 94 opposite the first section 90. The first section 90 includes a tapered edge which may taper from a central portion 92 of the retaining wall 88 towards the substantially flat section 48 of the handle 18. The second section 94 includes a curved corner adapted for helping to eliminate or minimize sharp edges that may otherwise cause discomfort to the user of the tray 74. In one exemplary embodiment, the wall 88 may also be slightly curved to correspond to the posterior portion of the dentition.

The U-shaped frame 76 may be assembled to the handle 18 by inserting the post 84 into a receiving bore 86 of the plastic handle 18. The post 84 and the receiving bore 86 may incorporate detents for a secured connection. Alternatively, the post 84 may be secured to the receiving bore 86 using glue or adhesive. In another embodiment, the U-shaped frame and the handle 18 may be integrally molded, for example, by over-molding a polymeric sleeve over portions of the U-shaped metal frame.

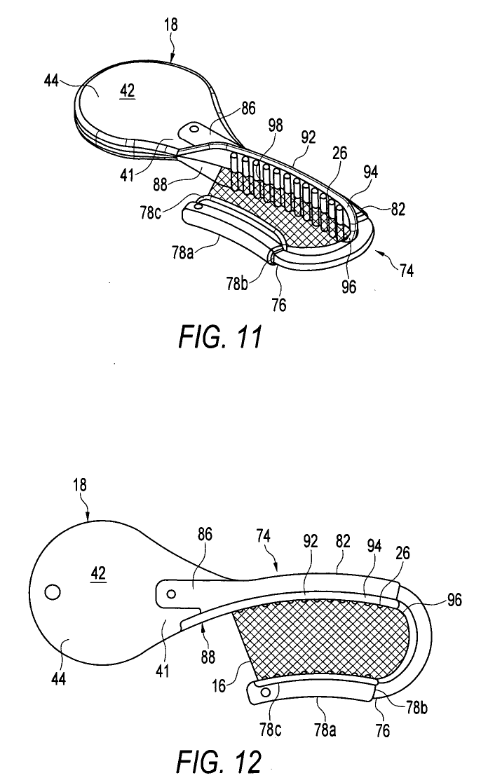

In one embodiment, the first elongated portion 78 of the U-shaped frame may be covered with a polymeric portion 78a, as shown in FIGS. 11 and 12, or uncovered, as shown in FIG. 7, 8 or 9.

FIG. 7c shows a perspective view of the U-shaped frame 76 prior to its attachment to the polymeric portion of the tray. In an exemplary embodiment, the frame 76 is hollow and may have a slit or a channel 96 extending the length of the interior surface of the frame 76. The screen 16 may be then placed in the slit 96 and pinched down to secure the screen to the frame. In an alternative embodiment, the frame 76 may include a core such that the frame is not hollow or is coreless.

FIG. 7b shows a perspective view of a polymeric sleeve 78a including a bore 78b throughout its length for fitting around the first elongated portion 78 of the U-shaped frame 76, shown in FIG. 7c. As noted above, the arch 78a may be formed separately from the U-shaped frame and then assembled afterwards onto at least a portion of the first elongated portion 78, or it may be integrally molded, for example, over-molded onto at least a portion of the first elongated portion 78 of the U-shaped frame 76. The assembled structures are exemplified in FIGS. 11 and 12.

The outer arch 78a may also include a retaining wall 78c, which is exemplified as an integrally cast or molded piece, as shown in FIG. 7b. In one embodiment, the retaining wall 78c may be tapered towards at least one of the ends.

FIG. 11 shows a perspective view of one embodiment of the posterior tray which may have structures similar to those described above, for example, in FIG. 7. In addition, at least a portion of the first elongated portion 78 is covered with a polymeric sleeve 78a. The sleeve 78a may be integrally molded to the first elongated portion 78 and has a retaining wall 78c, as mentioned above, in one embodiment. In another embodiment, the sleeve 78 may be separately constructed with a retaining wall 78c, and a bore 78b throughout its length, through which the first elongated portion 78 may be inserted.

FIG. 12 shows the top view of the embodiment of FIG. 11. In the orientation shown, the retaining wall 88 is shown to have a curvature that matches the curvature of the second elongated section 94 of the U-shaped frame 76. In one exemplary embodiment, the retaining wall 88 is not physically attached to the U-shaped frame 76 or the second elongated section 94 of the U-shaped frame. In another exemplary embodiment, the retaining wall 88 may incorporate means for attaching the second portion 94 or the central portion 92 of the wall to the frame 76. Such means include glue, adhesive, or detents.

In this embodiment, the screen material 16, which may be woven or non-woven, as noted above, may be attached or bounded to the posterior tray only about the polymeric portion 82 and the polymeric sleeve 78a. A hole may be present towards the free end of the polymeric sleeve 78a, adapted for receiving a hanging label (not shown), having a patient's vital information.

In one exemplary embodiment, the handle 18 may include a dimple section 42 defined by the ramp 44, as previously discussed.

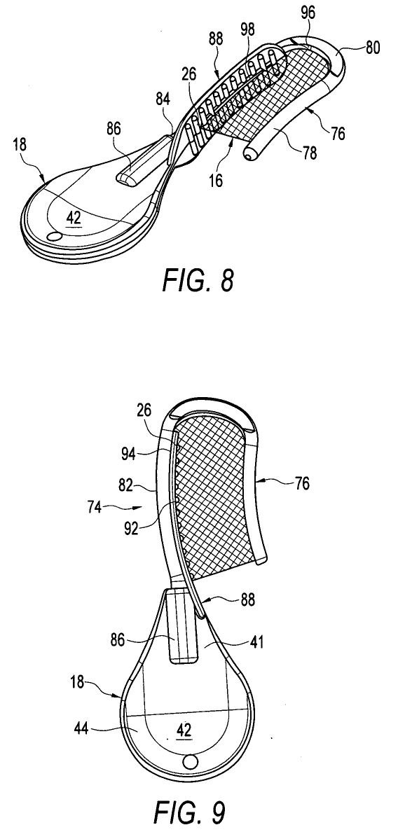

Referring now to FIG. 8, the screen 16 is shown to be attached to the U-shaped frame 76. In an exemplary embodiment, the frame 76 is hollow and may have a slit or a channel 96 extending the length of the interior surface of the frame 76, as discussed above in FIG. 7c. The screen 16 may be then placed in the slit 96 and pinched down to secure the screen to the frame. In an alternative embodiment, the frame 76 may include a core such that the frame is not hollow or is coreless.

In one exemplary embodiment, the retaining wall 88 similarly may include a gap or a slit 98 along at least a portion of its centerline. The screen 16 slides between the slit 98 when the U-shaped frame 76 is assembled to the handle 18 by inserting the post 84 into the receiving bore 86 of the handle 18. Similar to the other tray embodiments discussed elsewhere herein, the retaining wall 88 includes a plurality of spaced-apart ribs 26.

FIG. 9 is a top view or plan view of the posterior tray 74. In the orientation shown, the retaining wall 88 as shown has a curvature that matches the curvature of the second elongated section 94 of the U-shaped frame 76. In one exemplary embodiment, the retaining wall 88 is not physically attached to the U-shaped frame 76 or the second elongated section 94 of the U-shaped frame. In another exemplary embodiment, the retaining wall 88 may incorporate means for attaching the second portion 94 or the central portion 92 of the wall to the frame 76. Such means include glue, adhesive, or detents.

In one exemplary embodiment, the handle 18 includes a dimple section 42 defined by the ramp 44, as previously discussed. However, the base section 41 of the handle 18 may be slightly narrower than the handle any may incorporate the receiving bore 86. Overall, the tray 74 may be sized so that the posterior portion of a subject's dentition may be taken. The tray 74, and other trays discussed elsewhere herein, may incorporate a silver, white, blue, or red finish or other colors to be determined during manufacturing of the tray. A tray may also be used with a bigger person, and a smaller tray may be used with a smaller person, as noted before.

The U-shaped frame 76 may be made of any metal or metallic alloy, as discussed above. In one embodiment, the U-shaped frame may be made from a flattened wire, which may be formed by using any impact forces such as coining or stamping. The flattened wire has an added advantage of having smooth surfaces for patient comfort even if the polymeric sleeve 78a is absent from the construction. In another embodiment, the U-shaped frame may be cast or molded. In a further embodiment, the U-shaped frame may be machined. In some embodiments, the metallic parts may have to be de-burred to minimize any sharp edges.

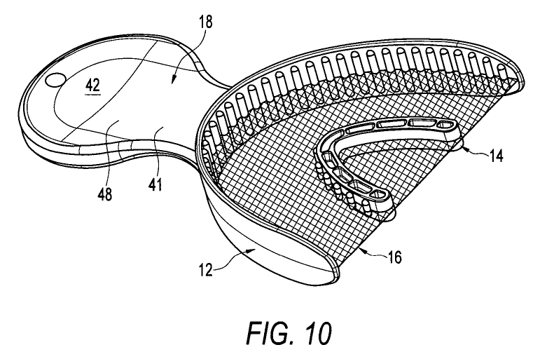

As with the description of the ribs, the description of other tray parts, such as the handle 18 and the different materials that may be used to mold the tray, with respect to the full arch is equally applicable to all the other arches and embodiments described elsewhere herein. Also, although the exemplified embodiments of the invention have been described with some specificity, the description and drawings set forth herein are not intended to be delimiting, and persons of ordinary skill in the art will understand that various modifications may be made to the embodiments discussed herein without departing from the scope of the invention, and all such changes and modifications are intended to be encompassed within the appended claims. Various changes to the triple trays described elsewhere herein may be made including changes to the size of the tray, the number of ribs, the spacing of the ribs, the slope or taper of various structures, the absence of a bore on the handle, such as shown in FIGS. 7a, 10 and 11, and the type of screen to be used. Accordingly, many alterations and modifications may be made by those having ordinary skill in the art without deviating from the spirit and scope of the invention.

What is claimed is:

1. A triple tray for taking an impression of a dentition comprising:
an inner wall;
an outer wall having a handle attached thereto;
a screen connected to both the inner wall and the outer wall and defining at least one channel; and
a plurality of ribs disposed along at least one surface of the outer wall and at least one surface of the inner wall;
wherein the handle comprises a dimple defined by a tapered ramp comprising a tapered surface having a radially outwardly incline from a flat portion of the handle towards a periphery of the handle.

2. The triple tray of claim 1, wherein the inner wall and the outer wall are sufficiently long to enable capturing a full dentition.

3. The triple tray of claim 1, wherein the inner wall and the outer wall are sufficiently long to enable capturing a ¾-dentition.

4. The triple tray of claim 1, wherein the plurality of ribs are present in a substantially transverse direction.

5. The triple tray of claim 1, wherein at least one portion of the tray is made from a polymer, a polymeric alloy, a polymeric composite or combinations thereof

6. The triple tray of claim 1, wherein the plurality of ribs are disposed along at least one of an inner wall surface of the outer wall and the inner wall surface of the inner wall, for facilitating gripping by an impression material.

7. The triple tray of claim 6, wherein the plurality of ribs are substantially evenly spaced-apart along the inner wall of the outer wall.

8. The triple tray of claim 1, wherein at least one of the plurality of ribs comprises an elongated wall structure, said elongated wall structure is positioned vertically relative to a plane defined by the handle.

9. The triple tray of claim 1, wherein the screen is made from a material selected from a group consisting of woven-type material, non-woven-type material and combinations thereof.

10. The triple tray of claim 1, wherein the handle comprises a bore.

11. The triple tray of claim 1, wherein at least one of the plurality of ribs is present in a substantially longitudinal direction.

12. The triple tray of claim 1, wherein the tapered ramp is U-shape in configuration.

13. The triple tray of claim 1, wherein the handle is integrally molded with the outer wall.

14. The triple tray of claim 9, wherein the woven-type material is a gauze material.

15. The triple tray of claim 9, wherein the non-woven-type material is a spun-bonded material.

16. The triple tray of claim 1, wherein at least one of the plurality of ribs comprises an elongated wall structure, said elongated wall structure is positioned at an angle to a plane defined by the handle.

17. The triple tray of claim 1, further comprising at least one rib on an outer wall surface of the outer wall.

18. The triple tray of claim 1, wherein the inner wall and the outer wall are sufficiently long to enable capturing only an incisor and a cuspid portion of a dentition.

19. The triple tray of claim 5 wherein said polymer is selected from a group consisting of a polyamide; a polystyrene; a polyformaldehyde; a polyaryletheretherketone (PEEK); a polycarbonate (PC); a PC blend; a polyphenylene sulphide; an acrylic polymer; acrylonitrile butadiene styrene (ABS); a polyacetal; a polyolefin; a polyester; a polyvinylchloride; a polyetherimide; a liquid crystal polymer and combinations thereof.

20. A triple tray for taking an impression of a dentition comprising:
an inner wall;
an outer wall having a handle attached thereto;
a screen connected to both the inner wall and the outer wall; and
a plurality of ribs disposed along an inner wall surface of the outer wall and the inner wall surface of the inner wall for facilitating gripping by an impression material;
wherein a plurality of openings separate the inner wall surface of the inner wall from an outer wall surface of the inner wall; and the handle comprises a dimple defined by a ramp comprising an inclined surface extending adjacent a periphery of the handle.

21. The triple tray of claim 20, wherein said at least of a portion of the handle is writable

22. The triple tray of claim 20, wherein the plurality of ribs are substantially evenly spaced-apart along the inner wall of the outer wall.

23. The triple tray of claim 20, wherein at least one of the plurality of ribs comprises an elongated wall structure, said elongated wall structure is positioned vertically relative to a plane defined by the handle.

24. The triple tray of claim 20, wherein the screen is made from material selected from the group consisting of a woven-type material, a non-woven-type material and combinations thereof.

25. The triple tray of claim 20, wherein the screen comprises of a spun polyester.

26. The triple tray of claim 20, wherein the handle comprises a bore.

27. The triple tray of claim 21, wherein the handle comprises an information indicia.

28. The triple tray of claim 26, wherein the handle comprises an information indicia.

29. The triple tray of claim 20, wherein the tapered ramp is U-shape in configuration.

30. The triple tray of claim 20, wherein the handle is integrally molded with the outer wall.

31. The triple tray of claim 24, wherein the woven-type material is a gauze material.

32. The triple tray of claim 20, further comprising at least one rib on an outer wall surface of the outer wall.

33. A triple tray for taking an impression of a dentition comprising:
a metal frame comprising a first elongated portion, a curved portion, a second elongated portion, and a post;
a plastic handle comprising a retaining wall, a receiving bore, and a dimple defined by a ramp comprising an inclined surface extending along a periphery of the handle;
and a screen;
wherein said post is received in the receiving bore of said handle.

34. The triple tray of claim 33 wherein said screen is attached to the first elongated portion, the curved portion, and the second portion of the metal frame to define an upper channel and a lower channel.

35. The triple tray of claim 34, where the screen is attached to the first elongated portion and the second elongated portion of the metal frame to define an upper channel and a lower channel.

36. The triple tray of claim 34, wherein the second elongated portion of the metal frame is secured to the retaining wall.

37. The triple tray of claim 34, wherein the retaining wall comprises a slit.

38. The triple tray of claim 34, wherein the screen is made from a material selected from a group consisting of woven-type material, non-woven-type material and mixtures thereof.

39. The triple tray of claim 34, wherein the first elongated portion of the metal frame is secured to a second retaining wall.

40. The triple tray of claim 34, wherein the second retaining wall comprises a portion of a polymeric sleeve covering at least a portion of the first elongated portion.

41. The triple tray of claim 34, wherein the ramp is U-shape in configuration.

42. The triple tray of claim 34, wherein the metal frame is made from a material selected from a group consisting of aluminum, stainless steel, magnesium, brass, copper, nickel/titanium alloy, or combinations thereof.

43. The triple tray of claim 40 wherein said at least a portion of the first elongated portion is over-molded with the polymeric sleeve.

44. The triple tray of claim 34 wherein said screen is secured to the polymeric sleeve.
